(19) United States
(12) Patent Application Publication
(10) Pub. No.: US 2007/0188661 A1
(43) Pub. Date: Aug. 16, 2007

(54) IMAGE PROCESSING METHOD CAPABLE OF ADJUSTING HUE AND SATURATION OF SPECIFIC COLORS AND RELATED IMAGE PROCESSING APPARATUS THEREOF

(76) Inventors: Szu-Ping Chen, Hsin-Chu Hsien (TW); Yen-Hung Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/672,968

(22) Filed: Feb. 9, 2007

(30) Foreign Application Priority Data
Feb. 14, 2006 (TW) 095104949

(51) Int. Cl. H04N 9/64

(52) U.S. Cl. 348/649

(57) ABSTRACT

An image processing method for adjusting image data of an image includes selecting a region according to a first parameter, adjusting the hue of at least one pixel of the image corresponding to the region according to a second parameter, and adjusting the saturation of the pixel corresponding to the region according to a third parameter.

### BACKGROUND OF THE INVENTION

1. Field of the Invention

The present invention relates to an image processing method and related image processing apparatus thereof, and more particularly, to an image processing method capable of adjusting hue and saturation of specific colors and related image processing apparatus thereof.

2. Description of the Prior Art

In general, manufactures of displays utilize a method of OSD (on-screen display) for allowing users to adjust hue and saturation of colors of images. Users then utilize the OSD to slightly adjust the colors of the images. For example, the user adjusts the hue of red color to approach purple color.

Adjusting the hue can change the color of an image. The prior art method of adjusting image hue is adjusting the angle of the chrominance component (U, V or Cb, Cr) in the component video signal YUV or YCbCr to change the colors. Please refer to FIG. 1. FIG. 1 is a diagram illustrating a color palette 100 for adjusting the hue according to the prior art. As FIG. 1 shows, the users adjust the hues by adjusting the colors in all domains. For the color palette 100, if the user adjusts one color, the color palette 100 turns a specific angle, and all colors therefore change because of the user's hue adjustment. In the above-mentioned example, when a user adjusts the hue of red to nearby purple, the other colors change at the same time (the green is shifted towards the red domain etc.). This is not a satisfactory result for the user.

Adjusting the saturation makes an image more vivid. The prior art method of adjusting image saturation is by adjusting the gain of the chrominance component (U, V or Cb, Cr) in the component video signal YUV or YCbCr to increase vividness. Please refer to FIG. 2. As FIG. 2 shows, the adjusting curve of saturation is a linear curve in general. When the curve is changed to increase the gain of the chrominance component, meaning that the slope of the curve becomes greater, an image of domain 210 in FIG. 2 will correspond to a condition of over-saturation. When the curve is changed to decrease the gain of the chrominance component, meaning that the slope of the curve becomes smaller, the domain 220 in FIG. 2 represents that partial colors are not utilized, resulting in insufficient vividness in the displaying colors.

### SUMMARY OF THE INVENTION

It is therefore one of the objectives of the present invention to provide an image processing method capable of adjusting hue and saturation of specific colors and related image processing apparatus thereof to solve the problems in the prior art.

The claimed invention involves an image processing method for adjusting color data of an image. The image processing method includes selecting a hue adjusting domain according to a first predetermined parameter, and adjusting a hue of at least one pixel of the image corresponding to the hue adjusting domain according to a second predetermined parameter.

The claimed invention involves an image processing method for adjusting color data of an image. The image processing method includes selecting a hue adjusting domain according to a first predetermined parameter, and adjusting a saturation of at least one pixel of the image corresponding to the hue adjusting domain according to a second predetermined parameter.

The claimed invention involves an image processing apparatus for adjusting color data of an image. The image processing apparatus includes a selecting module for selecting a hue adjusting domain according to a first predetermined parameter, and a hue adjusting apparatus being coupled to the selecting module to adjusting a hue of at least a pixel of the image corresponding to the hue adjusting domain.

The claimed invention involves an image processing apparatus for adjusting a color data of an image. The image processing apparatus includes a selecting module for selecting a hue adjusting domain according to a first predetermined parameter, and a hue adjusting apparatus being coupled to the selecting module for adjusting a saturation of at least a pixel of the image corresponding to the hue adjusting domain.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a color palette for adjusting hue according to the prior art.

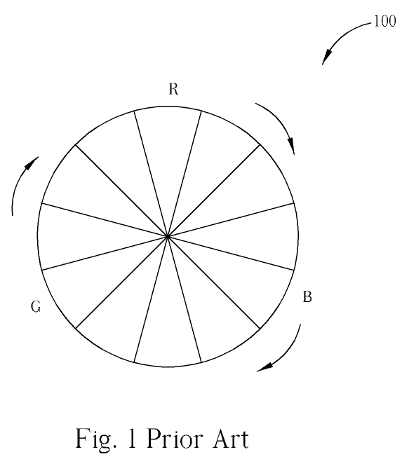

FIG. 2 is a diagram illustrating saturation adjusting curves according to the prior art.

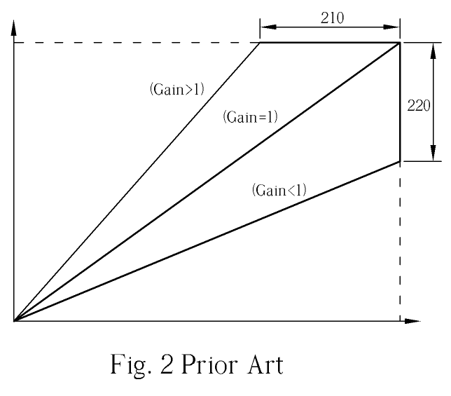

FIG. 3 is a diagram illustrating an image processing apparatus according to an embodiment of the present invention.

FIG. 4 is a diagram illustrating a color palette according to an embodiment of the present invention.

FIG. 5 is a diagram illustrating saturation adjusting curves according to an embodiment of the present invention.

### DETAILED DESCRIPTION

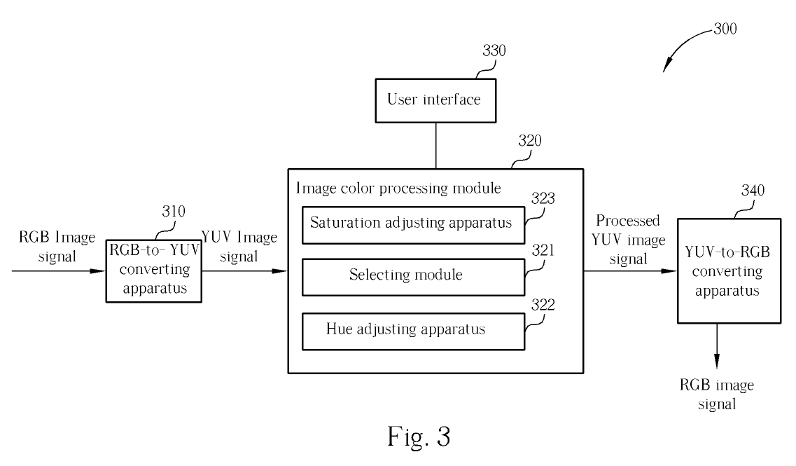

Please refer to FIG. 3. FIG. 3 is a diagram of an image processing apparatus 300 according to an embodiment of the present invention. As FIG. 3 shows, the image processing apparatus 300 includes an RGB-to-YUV converting apparatus 310, an image color processing module 320, a user interface 330, and a YUV-to-RGB converting apparatus 340. The image color processing module 320 includes a selecting module 321, a hue adjusting apparatus 322, and a saturation adjusting apparatus 323. Besides, the image color processing module 320 is coupled to the RGB-to-YUV converting apparatus 310, the user interface 330, and the YUV-to-RGB converting apparatus 340. The function and operation of each apparatus are disclosed as follows.

Firstly, the image processing apparatus 300 receives an image signal. In this embodiment, if the image signal is an RGB signal, and the hue or saturation adjustments are performed in a YUV domain as aforementioned, then the RGB-to-YUV converting apparatus 310 converts the RGB image signal into a corresponding YUV image signal. After that, the YUV image signal is outputted from the RGB-to-YUV converting apparatus 310 and is inputted into the image color processing module 320.

The image color processing module 320 adjusts the incoming image signal according to parameter(s) sent from the user interface 330. Please note that the user interface 330 can be an on-screen display (OSD) or a display data channel command interface (DDC/CI) or any of that sort, for allowing the users to setup their displays. In this embodiment, the users define their desired color that are adjusted at desired domain size, meaning that a hue adjusting domain in the color palette is selected, and the hue and saturation of the selected hue adjusting domain is thereby determined.

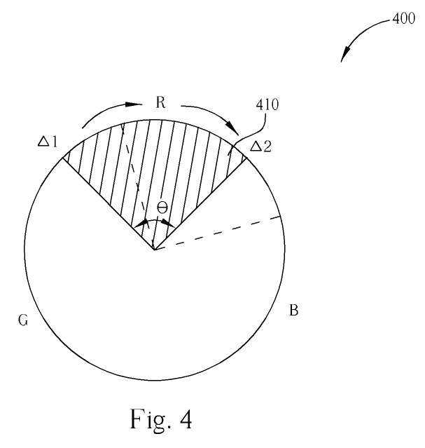

Please refer to FIG. 4. FIG. 4 is a diagram of a color palette 400 according to an embodiment of the present invention. As FIG. 4 shows, the color palette 400 includes a hue adjusting domain 410, where the hue adjusting domain 410 is the color domain set by the user through the user interface 330. For example, the user defines the angle θ, orientation points Δ1 and Δ2 of the color palette 400 by the user interface 330, in order to determine the position and the size of the hue adjusting domain 410. For example, the user can select the domains of red to pink to be the aforementioned hue adjusting domain 410. Then, the user can configure the hue and the saturation according to the selected hue adjusting domain 410.

As aforementioned, adjusting the hue means rotating the color palette 400 by a specific angle. Please note that, as FIG. 4 shows, the hue adjusting apparatus 322 only adjusts the hue of the pixel data corresponding to the hue adjusting domain 410 (i.e., the angle of rotating the hue adjusting domain 410), and the saturation adjusting apparatus 323 only adjusts the saturation of the pixel data corresponding to the hue adjusting domain 410.

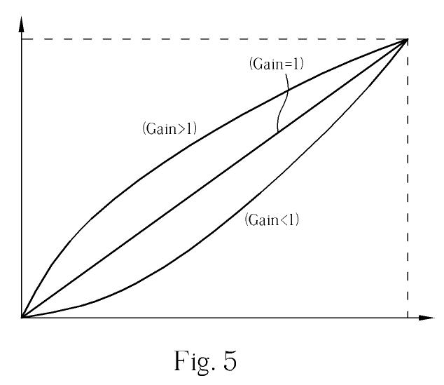

Please refer to FIG. 5. FIG. 5 is a diagram of saturation adjusting curves according to an embodiment of the present invention. As FIG. 5 shows, whether in the case of increasing or decreasing the gain of the chrominance component of the pixels, the saturation adjusting curves of the present invention are non-linear curves. This avoids the problem of having the image being over-saturated or lack of color vividness. Please note that the saturation adjusting curve can be built-in curves of the saturation adjusting apparatus 323. Users need only to set their desired saturation parameters, and the saturation adjusting apparatus 323 can therefore adjust the pixel data according to the built-in saturation adjusting curves and the parameters that the users desire.

Finally, in the image signal processed by the image color processing module 320, the pixel data corresponding to the hue adjusting domain 410 have be adjusted using the hue adjustment and the saturation adjustment according to the user's demand. Then, the image color processing module 320 outputs the processed image signal to the YUV-to-RGB converting apparatus 340. Subsequently, the YUV-to-RGB converting apparatus 340 converts the processed YUV image signal into an RGB signal and outputs the RGB image signal. Consequently, the RGB image signal output from the YUV-to-RGB can drive the display monitor (not shown) to show corresponding images.

Please note that the above-mentioned RGB-to-YUV converting apparatus 310 and YUV-to-RGB converting apparatus 340 are optional components. In other words, if the received image signal is a YUV image signal delivered from a front-end, the YUV image signal need not undergo the processing of the RGB-to-YUV converting apparatus 310. In the same way, if YUV image signal can directly drive the display monitor in a back-end, the processed YUV image signal need not undergo the processing of the YUV-to-RGB converting apparatus 340. These alternative designs shall still fall in the scope of the present invention.

Compared to the prior art, the image processing apparatus and related image processing method of the present invention can adjust the hue and saturation of pixel data in a specific domain on a color palette. Besides, the present invention adjusts the saturation of the pixel data in a non-linear way. Therefore, the present invention not only adjusts the specific color of the image, but also does not influence other colors unnecessarily. The present invention adjusts saturation and also avoids over-saturated or low-vividness results.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method for adjusting color data of an image, the image processing method comprising:
selecting a hue adjusting domain according to a first predetermined parameter; and
adjusting the hue of at least one pixel of the image corresponding to the hue adjusting domain according to a second predetermined parameter.

2. The image processing method of claim 1, wherein the first predetermined parameter and the second predetermined parameter are inputted by a user interface.

3. The image processing method of claim 1, further comprising:
adjusting the saturation of the pixel according to a third predetermined parameter.

4. The image processing method of claim 3, wherein the third predetermined parameter is inputted by a user interface.

5. The image processing method of claim 3, wherein the step of adjusting the saturation of the pixel further comprises adjusting the saturation of the pixel according to a non-linear saturation adjusting curve.

6. An image processing method for adjusting a color data of an image, the image processing method comprising:
selecting a hue adjusting domain according to a first predetermined parameter; and
adjusting the saturation of at least one pixel of the image corresponding to the hue adjusting domain according to a second predetermined parameter.

7. The image processing method of claim 6, wherein the first predetermined parameter and the second predetermined parameter are inputted by a user interface.

8. The image processing method of claim 6, wherein the step of adjusting the saturation of the pixel further comprises adjusting the saturation of the pixel according to a non-linear saturation adjusting curve.

9. An image processing apparatus for adjusting color data of an image, the image processing apparatus comprising:
a selecting module for selecting a hue adjusting domain according to a first predetermined parameter; and
a hue adjusting apparatus being coupled to the selecting module to adjust the hue of at least a pixel of the image corresponding to the hue adjusting domain.

10. The image processing apparatus of claim 9, further comprising:
a user interface being coupled to the selecting module and the hue adjusting apparatus in order to input the first predetermined parameter into the selecting module and to input the second predetermined parameter into the hue adjusting module apparatus.

11. The image processing apparatus of claim 10, wherein the user interface is an on-screen display or a display data channel command interface.

12. The image processing apparatus of claim 9, further comprising:
a saturation adjusting apparatus being coupled to the selecting module to adjust the saturation of the pixel according to a third predetermined parameter.

13. The image processing apparatus of claim 12, further comprising:
a user interface being coupled to the selecting module, the hue adjusting apparatus and the saturation adjusting apparatus, in order to input the first predetermined parameter into the selecting module, and to input the second predetermined parameter into the hue adjusting apparatus, and to input the third predetermined parameter into the saturation adjusting apparatus.

14. The image processing apparatus of claim 13, wherein the user interface is an on-screen display or a display data channel command interface.

15. The image processing apparatus of claim 12, wherein the saturation adjusting apparatus adjusts the saturation of the pixel according to a non-linear saturation adjusting curve.

16. The image processing apparatus of claim 9, being applied to a display monitor.

17. An image processing apparatus for adjusting color data of an image, the image processing apparatus comprising:
a selecting module for selecting a hue adjusting domain according to a first predetermined parameter; and
a hue adjusting apparatus being coupled to the selecting module for adjusting the saturation of at least a pixel of the image corresponding to the hue adjusting domain.

18. The image processing apparatus of claim 17, further comprising:
a user interface being coupled to the selecting module and the hue adjusting apparatus in order to input the first predetermined parameter into the selecting module and to input the second predetermined parameter into the saturation adjusting module apparatus.

19. The image processing apparatus of claim 18, wherein the user interface is an on-screen display or a display data channel command interface.

20. The image processing apparatus of claim 17, wherein the saturation adjusting apparatus adjusts the saturation of the pixel according to a non-linear saturation adjusting curve.
